(19) United States
(12) Patent Application Publication
(10) Pub. No.: US 2011/0147374 A1
(43) Pub. Date: Jun. 23, 2011

(54) ELECTRIC HEATING APPARATUS FOR HEATING INFANT FOOD BY MEANS OF ELECTROMAGNETIC RADIATION

(75) Inventors: Andreas Obst, Kandel/Pfalz (DE); Catharina Lübke, Winden/Pfalz (FR)

(73) Assignee: DBK David + Baader GmbH, Kandel (DE)

(21) Appl. No.: 12/644,093

(22) Filed: Dec. 22, 2009

(51) Int. Cl. H05B 6/10

(52) U.S. Cl. 219/647

(57) ABSTRACT

The present invention relates to an electric heating apparatus comprising a casing in which a receptacle containing a substance to be heated, preferably infant food, can be at least partly received. In the casing a radiation source for emitting electromagnetic radiation is arranged and the heating apparatus further comprises at least one reflector disposed in such way that it directs the emitted electromagnetic radiation onto the substance to be heated. In accordance with the invention, the reflector forms a hollow by which the receptacle can be at least partly received for heating, the radiation source being arranged with respect to the reflector such that a predominant portion of the electromagnetic radiation which is not directly incident on the receptacle is directed to the receptacle by the reflector.

### BACKGROUND OF THE INVENTION

The present invention relates to an electric heating apparatus comprising a casing in which a receptacle containing a substance to be heated, preferably infant food, can be at least partly received.

Currently widespread infant food heaters make use of electric energy which is transmitted to an intermediate medium and is given off to a receptacle containing the medium to be heated as heat source. Since long water which is heated and transmits its heat to the receptacle including the medium to be heated without transition to the steam phase has been known as intermediate medium. An example of such an infant food heater is shown in EP 06 96 429 B1. Those infant food heaters have the drawback, however, that the heating time is comparatively long, that large quantities of water have to be provided and the bottle is wet upon completion of the heating operation. But the major drawback of this arrangement is that the bottle has to be removed immediately after the optimum temperature of the medium to be heated is reached, because otherwise overheating by the comparatively high-temperature intermediate medium occurs. This is disadvantageous especially with arrangements in which several receptacles are to be simultaneously heated, as this is the case, for instance, in a hospital.

Infant food heaters having a so called marginal filling are filled with approx. 150 ml water and a nursing bottle including an infant formula or a jar containing a ready-to-serve meal is immersed into said filling. The marginal filling is in direct contact with an electrically heated element, e.g. a heating resistance or a PTC heating element, and serves as a heat transfer medium to the bottle and the formula contained therein. Consequently, first the marginal filling is heated which in turn heats the receptacle containing the infant food. With the aid of a thermostat or through a timer the heating element is switched off as soon as the marginal filling has reached a particular adjustable temperature. As for rapid heating of the food the temperature of the marginal filling is usually higher than the desired temperature of the infant food, however, even after switching off the heating energy supply the temperature of the food is further increased if the bottle is left in the infant food heater. Therefore, with such conventional infant food heaters the problem arises that when a very rapid heating is desired, a very high temperature of the marginal filling must be adjusted and the heating operation must be stopped by removing the food receptacle, when the temperature of the hot-water bath has reached a particular temperature. A fully automated and rapid heating of infant food is difficult by means of these conventional infant food heaters.

Moreover, when using a marginal filling the problem arises that a comparatively large quantity of energy is lost due to the bypass through the heat transfer medium.

A quicker and better defined heating of the food compared to this water bath heating can be achieved by the fact that the infant food heater is not filled with a marginal filling in the conventional meaning, i.e. a quantity of water reaching up to the edge of the cup when the receptacle is placed therein, but that only a very small quantity of water is introduced so that the water starts boiling upon supply of electric heating power.

The steam generated in this way serves as heat transfer medium in this case, encompasses the infant food receptacle and thus heats the food provided therein. An example of such arrangement is known from EP 1 350 455. Due to the high temperature and the evaporating enthalpy of the steam the food is heated very quickly by this heating apparatus. By condensation at the boundaries of the closed chamber, i.e. the cup walls, the receptacle and a possible cover, the water is supplied to a repeated heating and evaporation. Upon interruption of the supply of heating power the small quantity of evaporated water rapidly cools below the boiling point and no more heat is transferred to the food receptacle. Consequently, overheating of the food to be heated can be avoided.

The drawback of this arrangement consists in the fact that with this apparatus, too, water is required for operation and the bottle is wet after removing it. Moreover, a comparatively large amount of energy is lost again due to the bypass through a heat transfer medium, steam in this case.

Therefore, if the use of a heat transfer medium is intended to be dispensed with, as an alternative it is possible to make use of heating by means of microwave energy by placing the bottle in a conventional microwave stove. It is a problem, on the one hand, however, to adjust the correct temperature and, on the other hand, that a comparatively large and expensive appliance has to be provided which is not portable in contrast to the water-based infant food heaters.

From the U.S. Pat. No. 3,152,245 further an infant food heater making use of an infrared lamp instead of steam or water is known. Said infrared lamp is equipped with an internal reflector so that, on the one hand, it is a drawback of this arrangement that only the comparatively expensive lamps having an integrated reflector can be used as infrared radiation source. On the other hand, the arrangement becomes comparatively unmanageable, because a truncated reflector disposed as cover above the bottle is provided as an additional loose component.

### SUMMARY OF THE INVENTION

It is the object underlying the present invention to describe an electric heating apparatus for heating substances provided in a receptacle which requires no additional heat transfer medium such as water or steam, can be easily and cheaply manufactured and, while being portable, offers rapid and safe heating preferably of infant food.

The present invention makes use, inter alia, of the knowledge that it is not necessary to radiate across the medium to be heated over the entire length of the receptacle, as locally generated heat spreads in the liquid medium at sufficient velocity by the convection induced. Therefore, it is sufficient to direct the radiation only to a confined area of the receptacle so that the arrangement can be designed in a substantially more space-saving and compacter manner.

Compared to the arrangement known from U.S. Pat. No. 3,152,245, the solution according to the invention providing a reflector integrated in the housing of the apparatus offers the advantage that cheaper radiation sources can be employed and that the geometry of the arrangement is reduced. Furthermore, the energy utilization is increased so that shorter heating times can be reached by substantially less electric energy.

The reflector arrangement according to the invention can be employed especially with conventional glow lamps and halogen lamps but also with infrared heating lamps of various forms, tubular heating elements or light-emitting diodes (LED) which emit an appropriate heat spectrum.

According to an advantageous embodiment of the present invention, the reflector exhibits a plurality of reflector elements separated from each other. The reflector can either be divided into half-shells transversely to its longitudinal direction or else can be subdivided into individual reflector shields which in combination form the reflector. Furthermore, reflector elements having different active cross-sections can be employed to bundle the heat radiation in a particular area of the medium to be heated in an especially efficient manner.

Alternatively, the reflector may also be manufactured in one piece as rotation-symmetric hollow.

For inserting and holding the receptacle during the heating operation the electric heating apparatus according to an advantageous embodiment can comprise a holder for holding the receptacle at a defined position with respect to the radiation source.

Said holder can be made, for instance, of resilient bent wire which offers the advantage of being both cheap and sufficiently heat-resistant.

In order to make sure that operation without an inserted bottle is prevented and thus overheating is safely excluded, the surface for placing the bottle can be provided with a device detecting when a receptacle is inserted. This could be realized, for instance, by a press switch or a light barrier.

The reflector of the heating apparatus according to the invention should have a highly reflecting surface to reflect as much radiation as possible to the substance to be heated. The materials used for such reflectors are metals, e.g. sheets or die castings that are provided with appropriate coatings or else are polished for the purpose of improved reflection. It is also possible to make use of plastics or glass bodies which are coated in an appropriately reflecting manner, which are plated for instance. What is important is the fact that the reflector withstands the temperatures occurring.

According to an advantageous further development of the electric heating apparatus, the latter may also exhibit an electronic controller for controlling the duration and/or intensity of the energy supply by the radiation source. In the simplest case this is a timer circuit to determine, upon presetting, the heating of the substance in the receptacle by the duration of radiation.

The use of a cheap mechanical timer for controlling the electric heating apparatus is also possible.

Various configurations of the heating apparatus can be realized on the basis of the fundamental idea to bundle the infrared radiation locally in a restricted area of the liquid to be heated and to utilize the natural internal convection for distributing the heat.

In accordance with a first embodiment, the reflector has a rotation-elliptic cross-section, with the radiation source having a substantially point-shaped radiating characteristic and being disposed in a first focal point of the reflector. The area of the receptacle in which the radiation is to be focused is provided in a second focal point of the rotation-elliptic reflector. In this way, a particularly efficient bundling and exploitation of the emitted radiation and thus the required electric energy can be achieved.

As an alternative, the radiation source may also be different from the approximate point shape and encompass the heating chamber at least partly or have an oblong shape. It may be, e.g., at least partly toroidal or oval and may be surrounded by an adequate toroidal reflector system. Such toroidal radiator can be, for instance, an appropriately shaped IR radiator but also a circularly arranged series of LED.

Another conception permitted by the local heating of the liquid by means of electromagnetic radiation consists in a heating apparatus which does not receive the receptacle to be heated as upright standing apparatus but which is attached onto the receptacle such that the radiation is focused in an area in which the liquid to be heated is provided. Basically in this case it is also possible to employ an ellipsoidal reflector, wherein the receptacle in this case has to be partly covered by the heating apparatus to be attached, because the focal point in which the heating takes place is positioned within the reflector.

Alternatively, also a reflector arrangement guiding the radiation to the outside and bundling the same outside the casing can be selected, for instance a rotation parabolic. In this case, the heating apparatus to be attached has to accommodate only a very small part of the receptacle to be heated just to ensure sufficient mechanical stability. Concerning the materials to be used, the same is applicable to this solution as to the arrangement of the upright standing apparatus.

In accordance with an advantageous development, such heater radiating into the receptacle from the top can also be held in a fixture to ensure an improved stability and operating safety. In the simplest case such fixture is made of a bent wire. However, alternatively also a kind of casing into which the receptacle can be placed and which is made, e.g., of plastic material can be provided.

### BRIEF DESCRIPTION OF THE DRAWINGS

For the purpose of better understanding of the present invention, the same shall be illustrated by way of the embodiments shown in the following Figures. Equal elements are provided with the same reference numerals and the same part designations. Furthermore, also features or combinations of features of the shown and described different embodiments can represent, considered per se, independent inventive solutions or solutions according to the invention. They show in:

FIG. 1 a section of the electric heating apparatus according to the invention including an inserted nursing bottle;

FIG. 2 a side view of the heating apparatus from FIG. 1;

FIG. 3 a sectional view of the heating apparatus from FIG. 1 without beam guidance being drawn in;

FIG. 4 a view in the direction of the inserted nursing bottle onto the apparatus of FIG. 1;

FIG. 5 a perspective scheme of the heating apparatus according to the invention;

FIG. 6 a reflector arrangement and the bottom plate of a heating apparatus according to an alternative embodiment;

FIG. 7 another advantageous embodiment of an electric heating apparatus according to the invention including inserted bottle in a sectional view;

FIG. 8 perspective view of the arrangement of FIG. 7;

FIG. 9 another advantageous embodiment of an electric heating apparatus in the form of an attachment;

FIG. 10 a side view of another advantageous embodiment of an electric heating apparatus in the form of an attachment;

FIG. 11 a side view of the arrangement from FIG. 10 rotated about 90°;

FIG. 12 a top view on the arrangement of FIG. 10;

FIG. 13 perspective view of the arrangement of FIG. 10;

FIG. 14 perspective view of the arrangement of FIG. 10 in the operable state with inserted receptacle;

FIG. 15 a side view of another advantageous embodiment of an electric heating apparatus in the form of an attachment;

FIG. 16 a view from the top onto another advantageous embodiment of an electric heating apparatus with inserted receptacle;

FIG. 17 a schematic side view of the arrangement from FIG. 16 including a rod-shaped radiation source;

FIG. 18 partly opened perspective view of the arrangement from FIG. 17;

FIG. 19 a partly cut representation of another advantageous embodiment of the electric heating apparatus with inserted bottle;

FIG. 20 another advantageous embodiment of the heating apparatus with inserted bottle.

### DETAILED DESCRIPTION

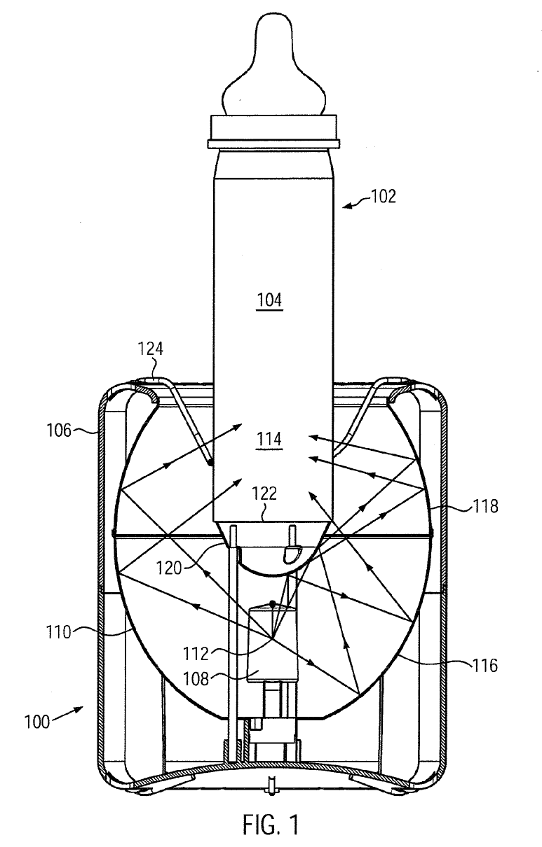

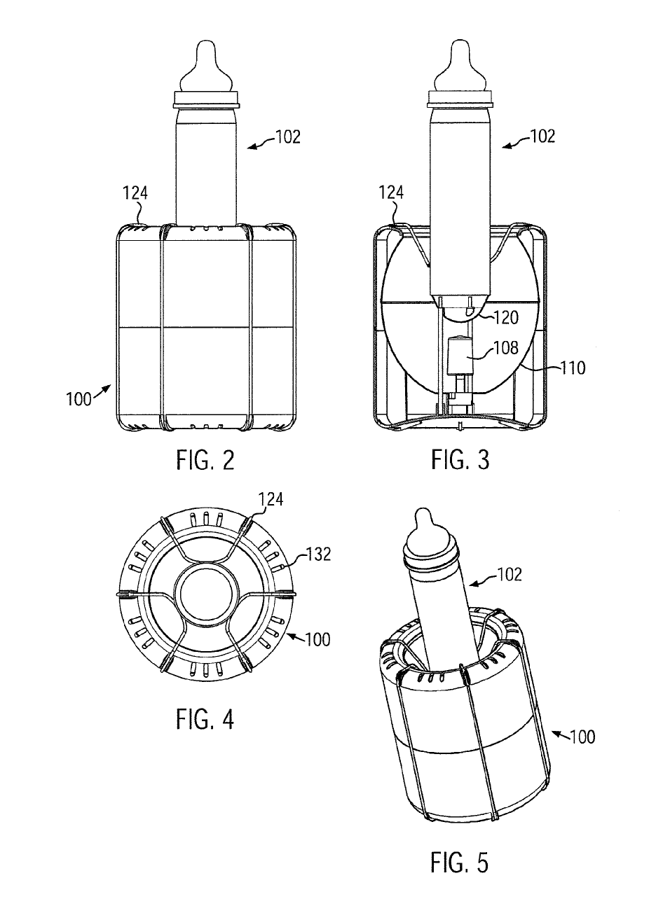

Hereinafter a first embodiment of the electric heating apparatus 100 shall be described in detail with reference to FIGS. 1 to 5. Frequently the term infant food heater is used in this context, but it is clear to those skilled in the art that the solution according to the invention is also applicable to other receptacles in which a substance is to be heated.

The heating apparatus 100 is shown in operable condition here, i.e. including an inserted receptacle 102 containing the substance 104 to be heated. In the present case the receptacle 102 is a nursing bottle and the medium 104 to be heated is liquid infant formula.

In a housing 106 consisting of plastic material, for instance, a radiation source, here halogen lamp 108, is arranged and is supplied with appropriate electric power. Venting slits 132 prevent the housing 106 from overheating during operation.

The output of the halogen lamp 108 typically ranges from 250 to 300 watt and thus a heating time of the infant formula 104 is reached which is approx. 30% less than that of a known steam infant food heater. 200 ml infant food can be heated from room temperature to 37 degrees Celsius within approx. 2 minutes.

This efficient energy utilization is made possible by the arrangement of the reflectors according to the invention: A first reflector element 110 is arranged so that the radiation source 108 is provided in a first focal point 112, while the radiation is focused on a second focal point 114 in which part of the substance 104 to be heated is provided. The infant food 104 provided there is heated by bundling the radiation in the area 114 and an induced convection occurs in the medium 104 by the temperature difference.

In this way the heat is evenly spread so that the entire infant food 104 is heated to the desired temperature. The first reflector element 110 exhibits a substantially rotation-elliptic cross-section and, in the shown arrangement, is made of a metal highly reflecting at the inside. For facilitated manufacture the reflector 110 is made in two pieces and consists of a first half-shell 116 and a second half-shell 118 connected by a circular seam area. Also other materials, such as e.g. appropriately coated plastic material or glass, are possible for the reflector.

In addition to this concave reflector element 110, another convex reflector element 120 is provided according to the present embodiment. The convex reflector element 120 is disposed such that it reflects the radiation of the radiation source 108 axially directed to the bottle back to the first reflector element 110 so as to prevent radiation from escaping to the outside directly upwards through the bottle.

The placing surface 122 moreover can be provided with a device (not shown in this Figure) for detecting when a receptacle 102 is inserted, for instance by a press switch. Such device prevents operation of the electric heating apparatus 100 without a bottle and thus avoids excessive heating of the apparatus.

In FIGS. 1 to 5 the means for current conduction and the control circuit are not represented. Possible are a timer, a control by temperature sensor or the like.

The embodiment of FIGS. 1 to 5 is characterized, inter alia, by the fact that the electromagnetic radiation does not leave the upper edge of the housing 106. In this way, high energy efficiency can be obtained with a comparatively compact design.

In order to mechanically secure the placed bottle 102 at its position with respect to the point in which the radiation is bundled, the heating apparatus 100 further comprises a holder 124 made of a bent wire. The holder fixes the receptacle and can be resilient. As a matter of course, also other embodiments, e.g. made of plastic material or punched and bent sheet, can be employed provided that the configuration permits fitting of different receptacle diameters and the material is sufficiently heat-resistant.

The embodiment shown in FIGS. 1 to 5 is moreover characterized in that the radiation source 108 can be assumed to be point-shaped. Also radiation sources other than a halogen lamp, such as a glow lamp, an IR heat lamp, a tubular heating element or a light-emitting diode (LED) equally having an all-round radiating characteristic, could be employed.

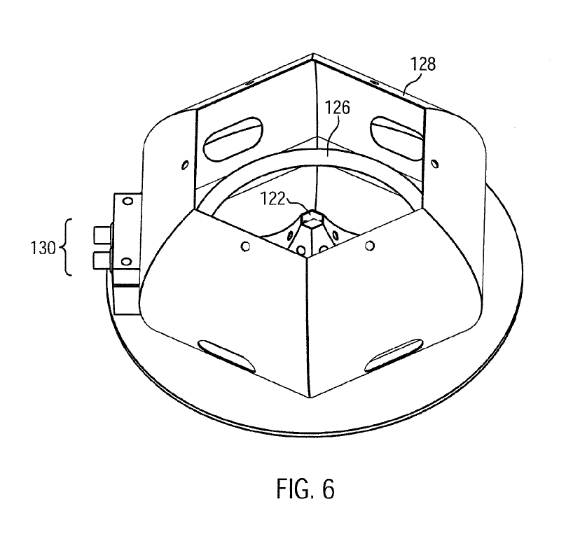

An alternative embodiment in which the radiation characteristic of the lamp is not point-shaped but approximately toroidal shall be illustrated hereinafter with reference to the FIGS. 6 to 8. In this solution a toroidal infrared radiator 126 is surrounded by a plurality of reflector segments 128 such that the radiation in turn is focused in a lower area of the placed bottle.

The six reflector segments 128 of FIG. 6 at the same time also constitute the placing surface 122 for the bottle 102. Electric connections 130 supply the radiator 126 with the required electric power.

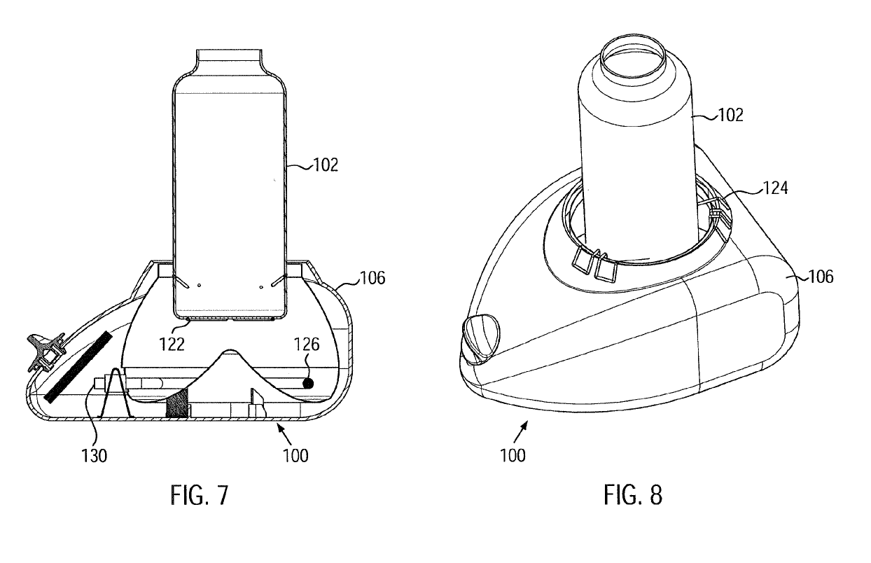

This arrangement can also be realized by a reflector manufactured in one piece, as shown in FIGS. 7 and 8. In this case, the receptacle is put on a placing surface 122 not represented in detail which can be formed by the fixture 124, for instance.

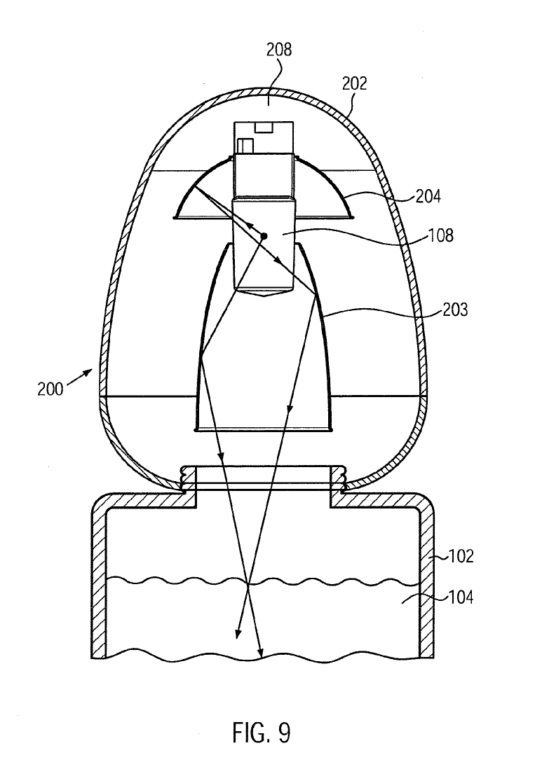

Another device-related solution making use of the principles according to the invention is an electric heating attachment 200 that may be considerably smaller than the heating apparatus 100 and is primarily characterized in that the radiation is focused in an area outside the casing 202. In the embodiment shown in FIG. 9 only a very small part of the receptacle 102 need to be enclosed by the housing 202, i.e. just as much as required to reach the mechanical stability.

The heating apparatus 200 is fixed on the receptacle by screwing or engagement, for instance. In order to obtain a beam guidance which permits to focus the radiation outside the housing 202, two parabolic reflector elements 204 and 206 are provided in the arrangement shown in FIG. 9.

Again a halogen lamp assumed to be point-shaped is provided as radiation source. In the area 208 the electric contact as well as the control circuit can be accommodated. The advantage of this embodiment resides in its especially compact and therefore easily portable design. The heating attachment according to the invention can be advantageously used for rapidly heating ready-to-serve meals in a jar.

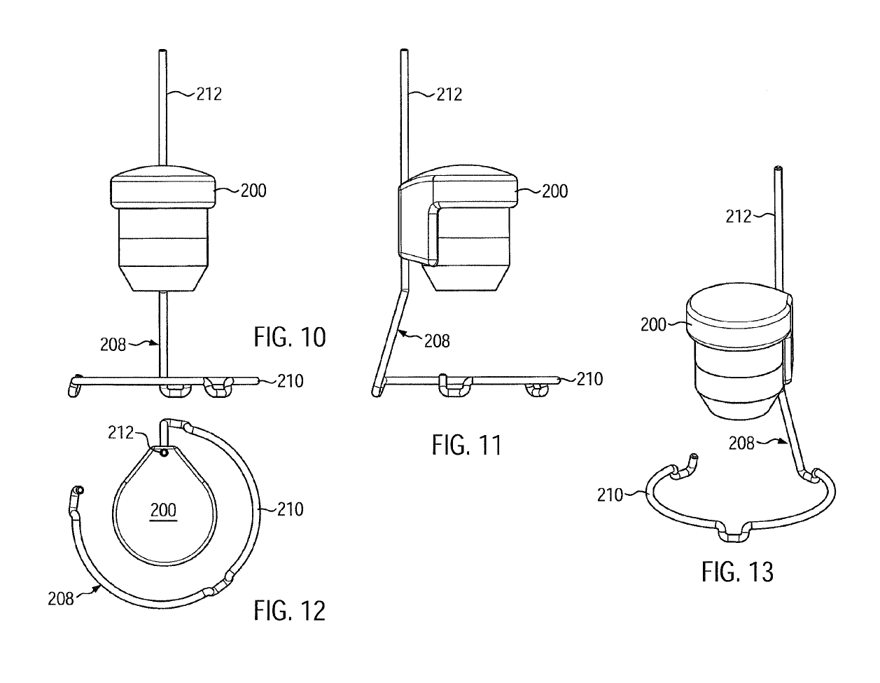

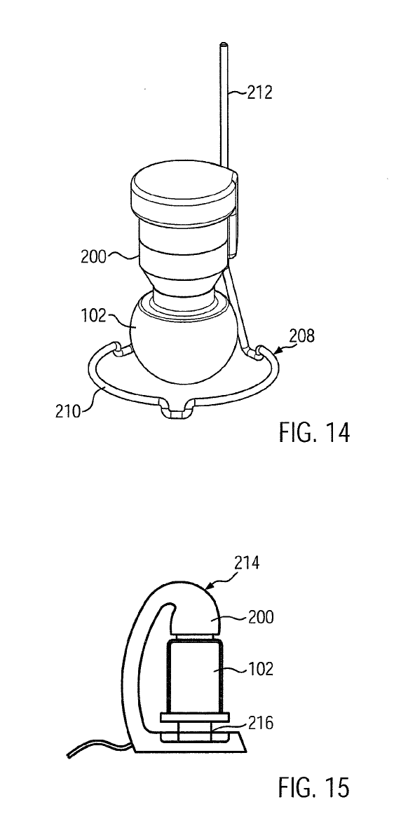

With reference to the FIGS. 10 to 14, an advantageous embodiment of the heating apparatus radiating from above into a receptacle is to be explained. The attachment 200 is mounted to a fixture 208 ensuring an improved stability of the entire arrangement in operation. In the simplest and cheapest variant, the fixture 208 is bent of rigid steel wire and includes an annular base surface 210 and a rod-shaped holder 212 connected thereto. The attachment 200 can be positioned to be adjustable in height by a movable mounting of the attachment 200 at the holder 212. Such height adjustment is advantageous, on the one hand, as adaptation to various bottle heights is possible and, on the other hand, because it can be ensured that the area in which the radiation is bundled always lies within the food. Moreover, the receptacle can be pressed onto the attachment such that light and heat are prevented from escaping.

Another major advantage of the embodiments of FIGS. 9 to 14 can be perceived in the fact that also particularly bent receptacles and other receptacles which cannot be inserted in a casing can be heated.

In FIG. 15 another possibility of designing this heating principle is illustrated in which the fixture and the attachment 200 are formed as integral device 214. The adjustability in height of the receptacle 102 can be realized in this case by a height adjustable placing surface 216 for the receptacle 102, for instance. This arrangement has the advantage that it is more stable in operation and more robust in storage.

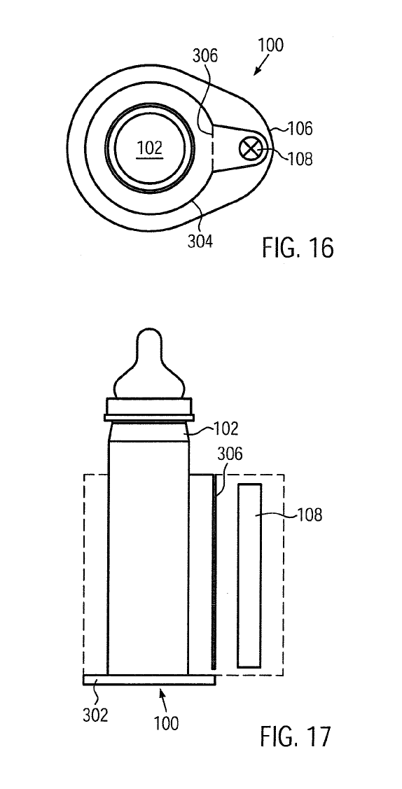

When handling electric infant food heaters it is a significant problem that in case that food spills out of the bottle, it may soil the reflector area and in the worst case the impurities may start burning due to the high temperatures. This is both a problem of hygiene and a factor that reduces the efficiency of reflection. Moreover, the previously explained arrangements have the drawback that placing the bottle or placing the heating attachment on the bottle is mechanically more critical than in the case of established systems. Hereinafter, with reference to the FIGS. 16 to 20, another concept shall be described in which placing the bottle is definitely facilitated, on the one hand, and manufacture of the reflectors becomes cheaper, on the other hand. In the solution shown here no rotation-symmetric or round reflectors are used and the receptacle is placed on a base plate 302.

On principle, this embodiment exhibits only one hollow provided with a source of electromagnetic radiation and a reflector 304 which appropriately directs the radiation to the inserted receptacle.

As an option, a protective member 306, for example a glass pane or a meshwork, e.g. made of wire, can protect the radiation source 108 against soiling. The circumferential reflector is accommodated in the casing 106, as schematically shown in FIG. 16. It can be made of metal, plated plastic material or plated glass, as already mentioned in the foregoing. The radiation source 108 can be rod-shaped, as shown in FIG. 17, and can be formed by a tubular heating element, for instance. Others of the already afore-mentioned possibilities can also be employed in this embodiment, as a matter of course.

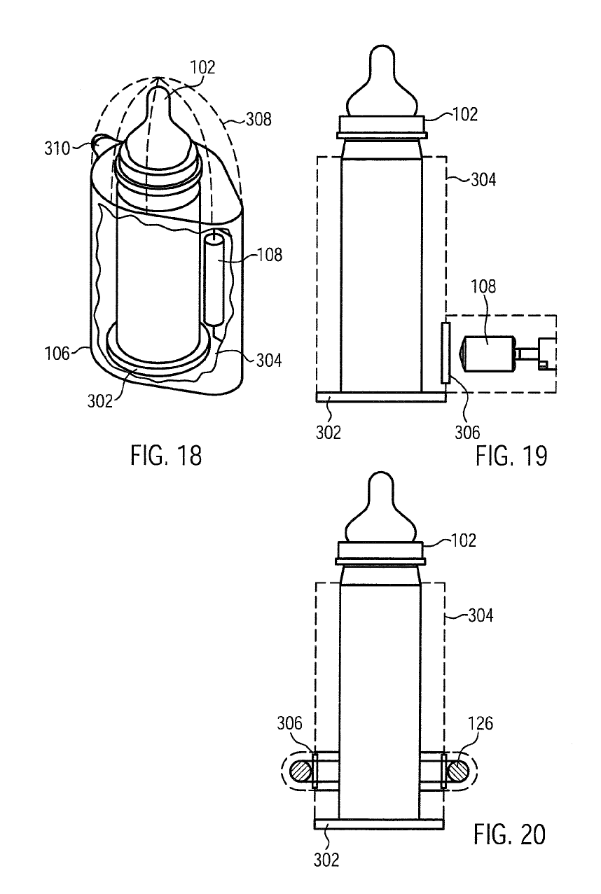

As indicated in FIG. 18, the heating apparatus 100 can moreover be provided with a hood 308 and/or an adapter ring 310 to prevent heat and light from escaping to the outside. Both the hood 308 and the adapter ring 310 can also be silvered at their inside to reflect the radiation.

In FIG. 19 an arrangement is shown in which the radiation source 108 has a point-shaped characteristic, whereas FIG. 20 illustrates a substantially toroidal radiation source 108.

In addition, it is clear to those skilled in the art that the reflector 304 of FIG. 16 can also be formed by plural reflecting elements which are not tightly interconnected.

1. An electric heating apparatus comprising a casing (106) in which a receptacle (102) containing a substance (104) to be heated can be at least partly received, wherein at least one radiation source (108) for emitting electromagnetic radiation is arranged in the casing (106) and wherein the heating apparatus (100) further comprises at least one reflector (110, 120, 128) disposed in such way that it directs the emitted electromagnetic radiation to the substance to be heated,
wherein the reflector (110, 120, 128) forms a hollow by which the receptacle (102) can be at least partly received for heating, and wherein the radiation source is arranged with respect to the reflector such that a predominant portion of the electromagnetic radiation which is not directly incident on the receptacle is directed to the receptacle by the reflector.

2. An electric heating apparatus according to claim 1, wherein the radiation source (108) is provided inside the hollow.

3. An electric heating apparatus according to claim 1, wherein the electromagnetic radiation includes infrared radiation.

4. An electric heating apparatus according to claim 1, wherein the radiation source (108) includes a glow lamp, a halogen lamp, an IR heating lamp, a tubular heating element or a light-emitting diode, LED.

5. An electric heating apparatus according to claim 1, wherein the reflector (110, 120, 128) includes a plurality of reflector elements separated from each other.

6. An electric heating apparatus according to claim 1, wherein the reflector (110, 120, 128) is manufactured in one piece as a rotation-symmetric hollow.

7. An electric heating apparatus according to claim 1, further comprising a holder (124) for holding the receptacle at a defined position with respect to the radiation source.

8. An electric heating apparatus according to claim 1, further comprising a sensor device for detecting the placed receptacle.

9. An electric heating apparatus according to claim 1, wherein the reflector (110, 120, 128) is made of metal or a plated plastic material or glass.

10. An electric heating apparatus according to claim 1, further comprising a mechanical or electronic control means for controlling the duration and/or intensity of the energy supply by the radiation source.

11. An electric heating apparatus according to claim 1, wherein the radiation source (108) is substantially point-shaped and is arranged in a first focal point (112) of the reflector (110, 120, 128), and wherein the receptacle containing the substance to be heated in operation is provided in a second focal point (114) of the reflector.

12. An electric heating apparatus according to claim 11, wherein the reflector (110, 120, 128) has a rotation-ellipsoidal cross-section.

13. An electric heating apparatus according to claim 1, wherein the radiation source (108) is substantially toroidal.

14. An electric heating apparatus according to claim 1, wherein the reflector has a rotation-parabolic cross-section arranged with respect to the radiation source such that the electromagnetic radiation is bundled to an area outside the casing.

15. An electric heating apparatus comprising a casing (106) in which a receptacle (102) containing a substance (104) to be heated can be at least partly received, wherein in the casing (106) at least one radiation source (108) for emitting electromagnetic radiation is arranged and wherein the heating apparatus (100) further comprises at least one reflector (110, 120, 128) disposed in such way that it directs the emitted electromagnetic radiation onto the substance to be heated, wherein in operation the heating apparatus (200) is attached to the opening of the receptacle.
